(19) United States
(12) Patent Application Publication
(10) Pub. No.: US 2002/0173901 A1
(43) Pub. Date: Nov. 21, 2002

(54) Control apparatus and control method

(75) Inventor: Hidekazu Yoshizawa, Atsugi-shi (JP)

Correspondence Address: FOLEY AND LARDNER, SUITE 500, 3000 K STREET NW, WASHINGTON, DC, 20007, US

(73) Assignee: UNISIA JECS CORPORATION

(21) Appl. No.: 10/125,524

(22) Filed: Apr. 19, 2002

(30) Foreign Application Priority Data
Apr. 20, 2001 (JP) 2001-123248

(51) Int. Cl. G06F 7/00; F02D 41/00; F01N 3/00

(52) U.S. Cl. 701/109; 701/115; 123/679; 60/276

(57) ABSTRACT

A plurality of control object models set with different waste times, respectively, are provided, and each of the control object models is identified to compute a predicted output using the identified control object models. The predicted output and an actual output detected are compared with each other, to select the control object model in which a difference therebetween becomes minimum as a final control object model. Then, an input to the control object is feedback controlled, while estimating an output after the lapse of waste time using the selected control object model to compare the predicted output with the output detection value.

### FIELD OF THE INVENTION

The present invention relates to a control apparatus and a control method for feedback controlling an input to a control object including a waste time, and particularly relates to a control apparatus and a control method for selecting an optimum control object model from a plurality of control object models.

### RELATED ART OF THE INVENTION

There has been known a control apparatus for setting an input to a control object including a waste time by estimating an output and a state generated after a lapse of waste time using a control object model in which the control object is represented by a transfer function.

In Japanese Unexamined Patent Publication No. 9-273438, there is disclosed an air-fuel ratio control apparatus comprising a first exhaust gas sensor that detects an air-fuel ratio on the upstream side of a catalyst apparatus and a second exhaust gas sensor that detects an oxygen concentration on the downstream side of the catalyst apparatus, wherein the oxygen concentration on the downstream side of the catalyst apparatus after a lapse of waste time is estimated using a control object model (identification model) of an exhaust system including the catalyst apparatus, a correction value for correcting the air-fuel ratio on the upstream side of the catalyst apparatus is computed by a sliding mode control, and also the air-fuel ratio is feedback controlled based on the correction value and the air-fuel ratio on the upstream side of the catalyst apparatus so that the oxygen concentration on the downstream side of the catalyst apparatus reaches a proper value.

However, as described above, in a case where the control using the control object model (identification model) is performed to the control object including the waste time, it is required that the waste time to be set to the control object model accurately corresponds to fluctuation of an actual waste time. Namely, identification of the control object model is performed by estimating each parameter, but the estimated parameters absorb a fluctuation component of the waste time, so that a state of the identified control object model becomes different from an actual state of the control object.

Particularly, in the conventional air-fuel ratio control for an internal combustion engine as described above, there may be occurred a large deviation between the waste time set to the control object model and the actual waste time due to large characteristic fluctuation of the control object. As a result, the air-fuel ratio control is performed using the identification model that has absorbed the deviation (fluctuation component) of the waste time, causing a problem in that high accuracy of the control cannot be maintained.

### SUMMARY OF THE INVENTION

The present invention has been achieved in view of the foregoing problem, and has an object of providing a control apparatus and a control method capable of performing a highly accurate control using a control object model corresponding to an actual waste time of a control object.

In order to achieve the above object, according to the present invention, a control object including a waste time is represented by a transfer function, a plurality of control object models set with different waste times, respectively, are stored (set), a parameter of each control object model is sequentially estimated to identify each control object model, a predicted output of the control object is computed using each identified control object model, the control object model in which a difference between the predicted output computed and an actual output detected becomes minimum is selected, and an input to the control object is feedback controlled while comparing the predicted output computed using the selected control object model with the actual output detected.

With such a constitution, it is possible that the control object model most correctly representing the waste time of the actual control object is selected, this selected control object model is used to predict the output of the control object, and the input to the control object is feedback controlled while comparing the predicted output with the output detection value. Thus, a highly accurate control corresponding to the actual state of the control object can be performed.

The other objects and features of this invention will become understood from the following description with accompanying drawings.

### BRIEF EXPLANATION OF DRAWINGS

FIG. 1 is a system diagram of an internal combustion engine according to an embodiment of the invention.

FIG. 2 is a control block diagram showing an air-fuel ratio feedback control unit (including a waste time compensation control) of a control apparatus according to the invention.

FIG. 3 is a control block diagram showing an example in which the control apparatus according to the present invention is applied to an air-fuel ratio feedback control apparatus for an internal combustion engine.

FIG. 4 is a flowchart showing the selection of a control object model (plant model) according to the present invention.

FIG. 5 is a control block diagram showing another embodiment according to the invention.

FIG. 6 is a graph showing a transient characteristic of an exhaust gas purification catalyst for an internal combustion engine.

### EMBODIMENTS

Embodiments according to the present invention will be described with reference to drawings as follows.

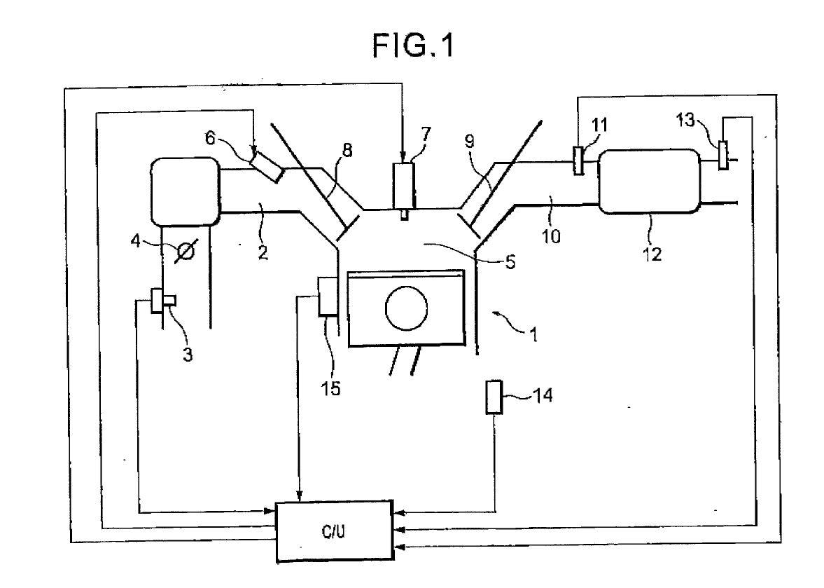

FIG. 1 is a system diagram of an internal combustion engine showing a first embodiment according to the present invention.

In FIG. 1, an air flow meter 3 that detects an intake air amount Qa is disposed in an intake passage 2 of an engine 1, and the intake air amount Qa is controlled by a throttle valve 4.

A fuel injection valve (injector) 6 that injects fuel and an ignition plug 7 that performs the spark ignition in a combustion chamber 5 are disposed in each cylinder of engine 1. An air-fuel mixture sucked through an intake valve 8 is compressed in combustion chamber 5 and then ignited by ignition plug 7.

An exhaust gas purification catalyst 12 is disposed in an exhaust passage 10, and a wide range type air-fuel ratio sensor (A/F sensor) 11 that linearly detects an air-fuel ratio corresponding to an oxygen concentration in the exhaust gas and a stoichiometric type oxygen concentration sensor (O₂ sensor) 13 are disposed on the upstream side and on the downstream side of exhaust gas purification catalyst 12, respectively.

The exhaust gas of engine 1 is discharged to exhaust passage 10 from combustion chamber 5 via an exhaust valve 9 to be released to an atmosphere via exhaust gas purification catalyst 12 and a muffler.

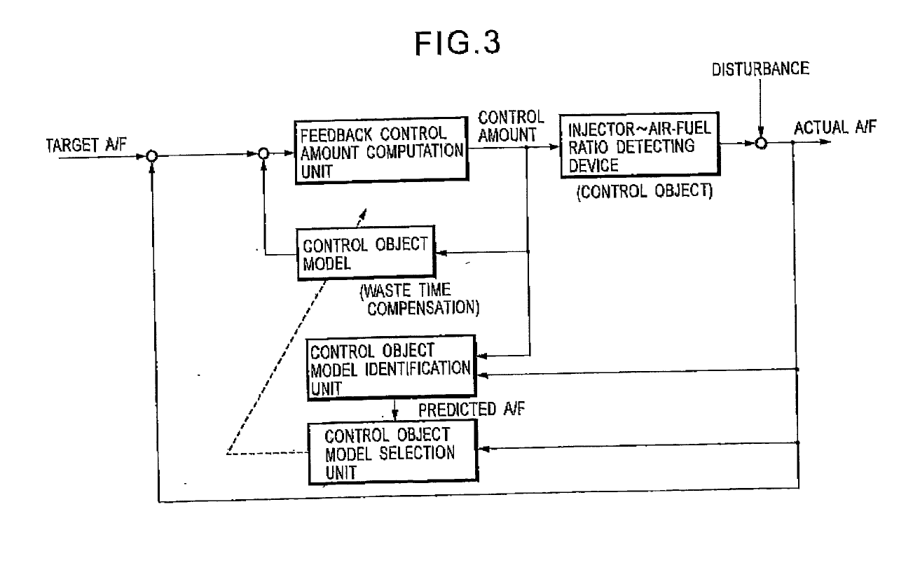

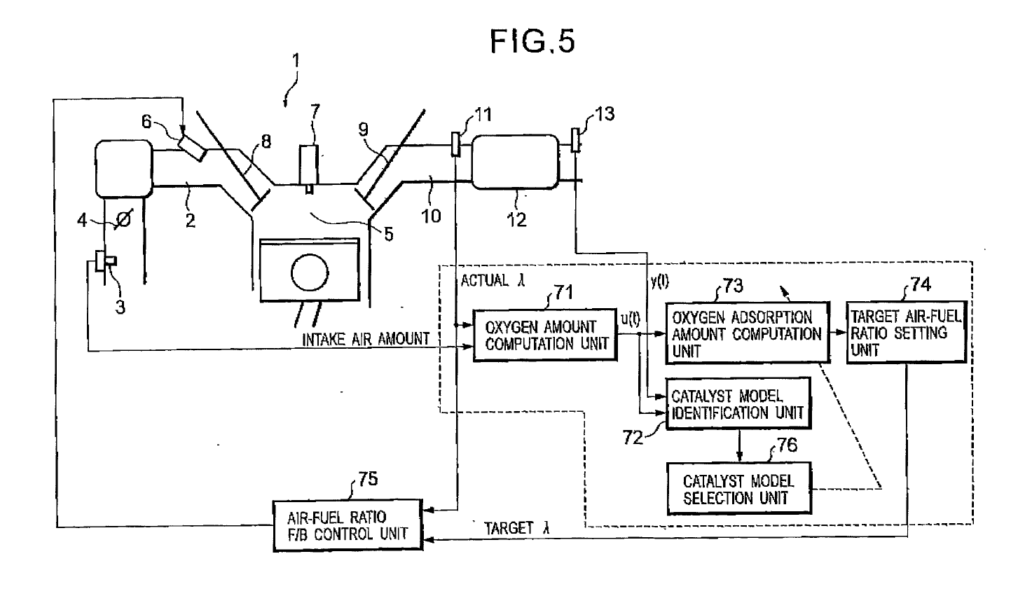

A control unit (C/U) 20 is input with signals from air-fuel ratio sensor 11, oxygen concentration sensor 13, a crank angle sensor 14, a water temperature sensor 15, air flow meter 3 and the like, to control throttle valve 4, fuel injection valve 6 and the like. Such a control unit (C/U) 20 constitutes a storing unit, a computation unit and a feedback control unit according to the present invention. In FIG. 3 and FIG. 5 to be described later, an air-fuel ratio feedback control will be described for each control block.

Hereafter, an air-fuel ratio feedback control according to the first embodiment of the invention will be described.

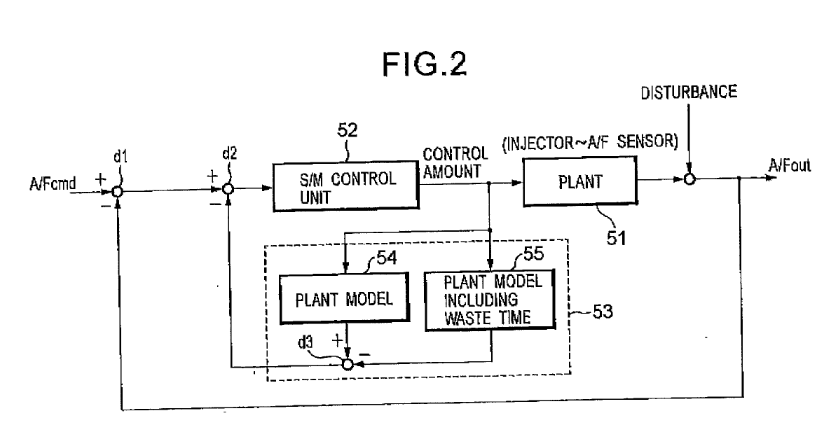

As shown in FIG. 2, an air-fuel ratio control unit in this embodiment is constituted such that a compensation computing unit 53 constituted based on a waste time compensation control proposed by Otto SMITH is provided to a feedback control system comprising a first subtraction unit (dl) that computes a deviation between a target air-fuel ratio A/Fcmd and a detected air-fuel ratio A/Fout, and a sliding mode control unit 52 (S/M control unit) that performs a sliding mode control based on the deviation to compute a control amount, and outputs the computed control amount to a control object (between a fuel injection device and an air-fuel ratio detection device in this embodiment, to be referred simply as a plant hereunder).

That is, by using a plant model representing the plant in a transfer function, the control amount from S/M control unit 52 is output to a third subtraction unit d3 through a plant model 54 without including a waste time (to be referred simply as plant model in the figure) and a plant model 54 including the waste time.

In third subtraction unit d3, a deviation between an output from plant model 54 and an output from plant model 55 including the waste time is computed, to be output to a second subtraction unit d2 disposed to an output side of first subtraction unit d1.

The deviation output to second subtraction unit d2 (namely, an output from compensation computing unit 53) is subtracted from the deviation between the target air-fuel ratio A/Fcmd and the detected air-fuel ratio (actual air-fuel ratio) A/Fout computed in first subtraction unit d1, to be output to S/M control unit 52. Thereby, an air-fuel ratio after a lapse of waste time is predicted using the plant models and a feedback control amount is computed by the sliding mode control while comparing the predicted air-fuel ratio with the detected air-fuel ratio.

Here, in this embodiment, a plurality of plant models including different waste times, respectively, are provided and each plant model is identified. A plant model in which a difference between a predicted air-fuel ratio computed using each identified plant model and an actual air-fuel ratio becomes minimum, is selected to be used for the feedback control. Thus, the air-fuel ratio feedback control is performed with high accuracy using the plant model most properly representing an actual control object that ever-changes.

FIG. 3 is a block diagram showing the air-fuel ratio feedback control according to the present embodiment.

Control contents of the present embodiment will be described as follows.

Firstly, setting of the control object model (plant model) will be described as follows.

A plant (control object) between fuel injection valve 6 and A/F sensor 11 is represented by a secondary autoregressive model (ARX model) taking the waste time into consideration, resulted in equations (1) and (2) in which (a₁, a₂, and b₀ are parameters):

A(z⁻¹)y(t)=z^{-k}b₀u(t)+e(t) (1)

A(z⁻¹)=1+a₁z⁻¹+a₂z⁻² (2)

in which y(t); actual air-fuel ratio, u(t); feedback control amount, e(t); irregular noise, and k; waste time (k≧1).

Here, in this embodiment, there are provided (stored) three kinds of plant models respectively set with three kinds of waste times, as the waste time k, namely, a reference waste time k₀ computed based on the intake air amount Qa or based on the intake air amount Q a, an exhaust gas temperature and the like; a waste time k₁ (=k₀−α₁) which is smaller than the reference waste time k₀; and a waste time k₂ (=k₀+α₂) which is larger than the reference waste time k₀. (Note, α₁, and α₂ are set arbitrarily.)

Next, the identification of the plant models to be performed at a control object model identification unit will be described. The following description is made on the identification of the plant model set with the reference waste time k₀ (reference plant model), but the identification of other plants models respectively set with other waste times is performed in the same manner.

From the above equations (1) and (2), an estimation parameter vector θ(t) and a data vector ψ(t−k) are represented by the following equations (3) and (4).

θ(t)={a₁(t),a₂(t),b₀(t)}^{T} (3)

ψ(t−k)={−y(t−1),−y(t−2),u(t−k₀)}^{T} (4)

Then, the identification of the plant model is performed by estimating each parameter (a₁, a₂, b₀) in on-line by utilizing a sequential least square method (RLS method) constituted by time-update equations shown in the following three equations (5)-(7).

θ(t)=θ(t−1)+{Γ(t−1)ψ(t−k₀)}e(t)/{1+ψ^{T}(t−k₀)Γ(t−1)ψ(t−k₀)} (5)

Γ(t)=[Γ(t−1)−{λ₂Γ(t−1)ψ(t−k₀)ψ^{T}(t−k₀)Γ(t−1)}/{λ₁+λ₂ψ(t)ψ^{T} (t−k₀)Γ(t−1)Γ(t−k₀)}]/λ₁ (6)

e(t)=y(t)−θ^{T}(t−1)ψ(t−k₀) (7)

Note, θ(t); parameter estimation value, Γ(t); covariance matrix, e(t); prediction error, λ₁ and λ₂; forgetting coefficients. In a case where there is no forgetting factor, λ₁=λ₂=1 and in a case where there is a forgetting factor, X₁=0.98 and λ₂=1.

As for an initial value of a parameter adjustment rule, α=1000, and θ(0)=0 (zero matrix), if Γ(0)=α·I (I is unit matrix).

Similarly, other plant models (namely, plant models respectively set with waste times k₁ and k₂) are identified.

Next, the selection of the plant model to be used for a final control to be performed at a control object model selection unit will be described.

First, by using each plant model as identified above, a predicted air-fuel ratio of each plant model is computed. The predicted air-fuel ratio thus computed and the detected actual air-fuel ratio are compared with each other, and a plant model in which a difference between the predicted air-fuel ratio and the actual air-fuel ratio becomes minimum, is selected.

As a result, using the selected plant model the air-fuel ratio feedback control is performed while compensating for the waste time.

In the embodiment, in order to make the switching of the plant models due to the selection of the plant model accurate and stable, only when the plant model in which the difference between the predicted air-fuel ratio computed and the detected actual air-fuel ratio becomes minimum is the same for predetermined times or more, such a plant model is selected.

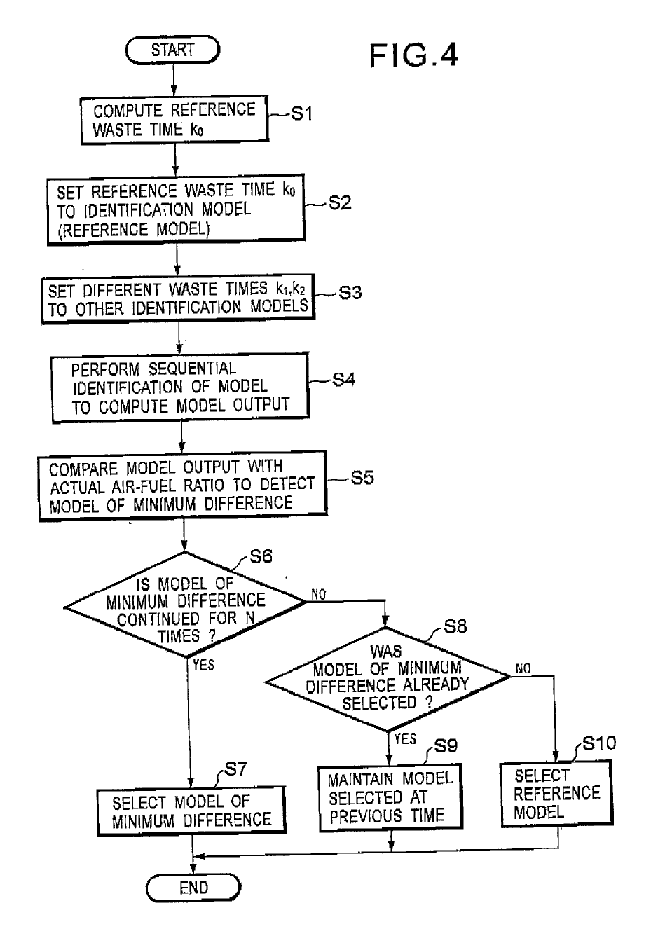

The selection of such a plant model is shown in a flowchart in FIG. 4.

In FIG. 4, at Step 1 (described as S1 in the figure and the same rule applied to subsequent steps), the reference waste time k₀ is obtained based on the intake air amount. The reference waste time k₀ may be set based on only the intake air amount or based on an exhaust gas volume flow amount computed based on the intake air amount, an exhaust gas temperature and the like.

At S2, a plant model (identification model) is set with the reference waste time k₀, to be a reference model.

At S3, different waste times k₁ (=k₀−α₁) and k₂ (=k₀+α₂) are respectively set to other plant models (identification models).

At S4, as described above, parameters of respective plant models are estimated in on-line by using the sequential least square method to and the sequential identification is performed. Then, a model output (that is, predicted air-fuel ratio) of each plant model identified is computed.

At S5, an actual air-fuel ratio is detected, and the model output (predicted air-fuel ratio) from each plant model and the actual air-fuel ratio are compared with each other, and the plant model in which a difference therebetween becomes minimum, is detected.

At S6, it is judged whether or not the plant model detected at S5 is continuously detected for a predetermined times or more. If the same plant model is continuously detected for the predetermined times or more, control goes to S7, wherein the detected plant model is selected as a plant model (control object model) to be used for the air-fuel ratio feedback control.

On the other hand, if the same plant model is not continuously detected for the predetermined times or more, control goes to S8.

At S8, it is judged whether or not a plant model in which the difference between the output of the plant model and the detected actual air-fuel ratio becomes minimum, is already selected.

If such a plant model is already selected, control goes to S9, wherein the plant model selected at the previous time (namely, currently selected plant model) is maintained as it is.

If the plant model in which the difference between the output of the plant model and the actual air-fuel ratio becomes minimum is not selected once yet, control goes to S10, wherein the reference model (namely, the plant model set with the waste time k₀) is selected to perform the air-fuel ratio feedback control.

As described above, the plant model most properly representing an actual state (waste time) of the control object is selected and the air-fuel ratio feedback control is performed using the selected plant model, thereby improving the control accuracy.

When the plant model in which the difference between the output of the plant model and the actual air-fuel ratio becomes minimum is continuously detected for the predetermined times (N times) or more, the selection (switching) of the plant model is performed. Thereby, control hunting can be prevented and also the plant model can be changed after a change in the control object (plant) is reliably detected. As a result, it becomes possible to realize a stable control.

Next, a second embodiment according to the invention will be described.

In this embodiment, an oxygen adsorption amount of an exhaust gas purification catalyst 12 (described as catalyst hereinafter) is computed to set a target air-fuel ratio of an exhaust gas at the upstream side of catalyst 12, and a fuel injection device is controlled so that the air-fuel ratio at the upstream side of catalyst 12 becomes the set target air-fuel ratio.

The setting of the target air-fuel ratio in this embodiment is executed according to a block diagram shown by dotted lines in FIG. 5.

That is, an exhaust system of from A/F sensor 11 (first oxygen concentration detection device) on the upstream side of catalyst 12 to O₂ sensor 13 (second oxygen concentration detection device) on the downstream side of catalyst 12 is represented by a catalyst model, in which an oxygen amount (oxygen amount sucked into catalyst 12) computed at an oxygen concentration computation unit 71 based on the actual air-fuel ratio detected by A/F sensor 11 is set as an input, and an oxygen concentration detected by O₂ sensor 13 is set as an output. This catalyst model is sequentially identified at a catalyst model identification unit 72 and the oxygen adsorption amount of catalyst 12 is computed using the identified parameter at an oxygen adsorption amount computation unit 73.

Then, a target air-fuel ratio at the upstream side of catalyst 12 is set at a target air-fuel ratio setting unit 74 so that the computed oxygen adsorption amount of catalyst 12 becomes an optimum oxygen adsorption amount to be set based on engine operating conditions, and the fuel injection device is controlled by an air-fuel ratio feedback control unit 75 so as to achieve the target air-fuel ratio.

In FIG. 5, the same elements as those in FIG. 1 are denoted by the same reference numerals. The description will be made in accordance with the block diagram in FIG. 5.

At oxygen amount computation unit 71, an oxygen amount that is sucked into catalyst 12 but is not used for oxidization and reduction is computed. Specifically, as shown in the equation (8), an oxygen intake amount affecting the oxygen adsorption amount of catalyst 12 is computed by multiplying the intake air amount Qa on a difference between the actual air-fuel ratio (actual λ) detected by A/F sensor 11 and a theoretical air-fuel ratio (λ=1).

u(t)=(actual λ−1)×Qa (8)

At catalyst model identification unit 72, the catalyst model (identification model) in which the oxygen intake amount u(t) computed at oxygen amount computation unit 71 is set to an input and an O₂ sensor detection value y(t) (that is, exhaust oxygen amount) on the downstream side of catalyst 12 is set to an output, is identified using the sequential least square method (RLS method).

Here, the catalyst model in this embodiment will be described.

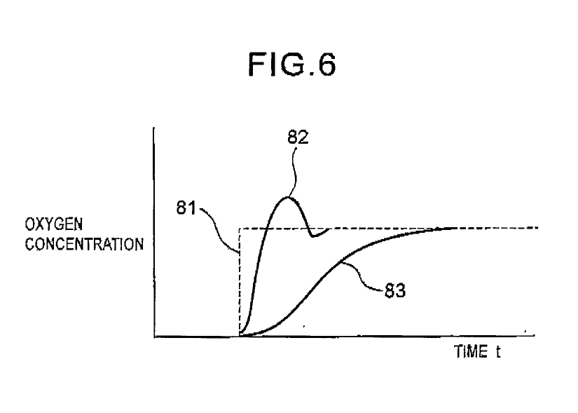

In this embodiment, as shown in FIG. 6, taking into consideration a case where the detection value (exhaust oxygen amount) of O₂ sensor 13 on the downstream side of catalyst 12 shows a relatively fast response (wave form 82) to an input (wave form 81) and a case where it shows a slow response (wave form 83), a first transfer function in which catalyst 12 is transfer functionalized in consideration of only the fast response (that is, fast time constant) and a second transfer function in which catalyst 12 is transfer functionalized in consideration of only the slow response (that is, slow time constant) are respectively computed, and a secondary transfer function obtained by composing these two transfer functions is treated as a final transfer function of catalyst 12. (Note, it is confirmed by the inventors' experiment that when such transfer functions (catalyst model) are used, oxygen adsorption behavior of the catalyst is shown with high accuracy.)

The transfer functionalization of catalyst 12, and the setting and identification of the catalyst model will be described in detail hereunder. In this embodiment, Freundlich type adsorption amount computing equation is used as an equation of computing an O₂ adsorption amount.

On the assumption that ν; O₂ adsorption amount of catalyst 12, p; O₂ intake amount of catalyst 12 (used as a substitute value for a partial pressure of O₂), the O₂ adsorption amount v is represented by the equation (9);

ν=ap^{1/n} (9)

wherein a; a constant determined by linearity of logarithm of O₂ absorption amount and logarithm of O₂ intake amount p (O₂ partial pressure), and n; a constant determined by linearity of logarithm of O₂ absorption amount and logarithm of O₂ intake amount p (O₂ partial pressure).

Firstly, a transfer function G1 (first transfer function) of catalyst 12 in consideration of fast time constant only is computed.

Increase and decrease components of O₂ adsorption amount are computed as follows, on the assumption that Δν; a change adsorption amount of O₂ from an equilibrium state where an O₂ adsorption amount of catalyst 12 is equal to an O₂ discharge amount of catalyst 12, and Δp; a change intake amount of O₂ from an equilibrium state where an adsorption amount of catalyst 12 is equal to an O₂ discharge amount of catalyst 12 (a change amount of O₂ partial pressure accompanying the change intake amount).

From the above equation (9),

ν+Δν=a(p+Δp)^{1/n}=ap^{1/n}(1+Δp/p)^{1/n}.

If this equation is expanded, then the following equation is obtained.

ν+Δν=ap^{1/n}{1+1/n·(Δp/p)+(1−n)/2n·(Δp/p)²+ . . . } (10)

From the above equations (9) and (10), O₂ change adsorption amount Δν can be represented by the equation (11). (In this embodiment, the approximation has been made considering up to a quadric term.)

Δν≈ap^{1/n}{1/n·(Δp/p)+(1−n)/2n·(Δp/p)²} (11)

If Δq is a change discharge amount of O₂ from the equilibrium state where the O₂ adsorption amount of catalyst 12 is equal to the O₂ discharge amount of catalyst 12, in the case of the fast time constant, the change adsorption amount Δν can be replaced by a difference between the change intake amount Δp and the change discharge amount Δq (Δν=Δp−Δq). Accordingly, from the above equation (11), the following equation (12) can be obtained.

ap^{1/n}{1/n·(Δp/p)+(1−n)/2n·(Δp/p)²}=Δp−Δq (12)

Then, if the equation (12) is subjected to Laplace transformation, the following equation is obtained.

ap^{1/n}/np·1/s²·ΔP+ap^{1/n}(1−n)/2np²·2/s³·ΔP=1/s²(Δp−ΔQ).

Then, this equation can be made to be the next equation (13).

ΔQ={1−ap^{1/n}/np−ap^{1/n}(1−n)/np²·1/s}ΔP (13)

Accordingly, the following equation can be obtained;

ΔQ/ΔP={1−ap^{1/n}/np−ap^{1/n}(1−n)/np²·1/s}=1−X1−X2/s

wherein X1=ap^{1/n}/np, and X2=ap^{1/n}(1−n)/np².

Then, if this equation is subjected to z transformation, then the equation (14) can be obtained, and this equation (14) is a first transfer function G1 representing catalyst 12 in the case of considering the fast time constant only.

$$\begin{matrix}Δ Q / Δ P = 1 - X1 - X2 / ( 1 - {z}^{- 1} ) = \{ ( 1 - X1 + X2 ) + \\ ( X1 - 1 ) {z}^{- 1} \} / ( 1 - {z}^{- 1} ) \\ = \{ ( 1 - X1 + X2 ) z + ( X1 - 1 ) \} / ( z - 1 ) ( = G1 )\end{matrix} \qquad ( 14 )$$

A transfer function G2 (second transfer function) of catalyst 12 in a case of considering the slow time constant only is computed. In the case of considering the abovementioned fast time constant only, consideration is made up to the quadric term of O₂ change adsorption amount Δν subjected to Tailor expansion (see equation (11)). In the case of considering the slow time constant only, the approximation is made by only a primary term. Accordingly, the O₂ change adsorption amount Δν is represented by the equation (15).

Δν≈ap^{1/n}{1/n·(Δp/p)} (15)

Here, in the case of considering the slow time constant only, O₂ change adsorption amount per unit time d(Δν)/dt is regarded to be the difference between the change intake amount Δp and the change discharge amount Δq (d(Δν)/dt=Δp−Δq). Therefore, the following equation (16) is obtained from the equation (15).

d(Δν)/dt=d{ap^{1/n}·(Δp/p)}/dt=Δp−Δq (16)

Then, if the equation (16) is subjected to Laplace transformation, the following equation is obtained.

ap^{1/n}/np·1/s²·ΔP·s=1/s²·(ΔP−ΔQ).

Then, this equation can be made to be the next equation (17).

ΔQ=(1−ap¹ⁿ/np·s)ΔP (17).

Accordingly, the following equation can be obtained;

ΔQ/ΔP=(1−ap^{1/n}/np·s)=1−X3s≈1/(1+X3s)=(1/X3)/(s+1/X3)

wherein X3=ap^{1/}/np.

Then, if this equation is subjected to z transformation, the following equation (18) is obtained. The equation (18) is the transfer function G2 in the case of considering the slow time constant only.

ΔQ/ΔP=(1/X3)/(1−z⁻¹e^{-T/X}³)(=G) (18)

A transfer function (final) Gs of catalyst 12 is computed as follows by composing the first transfer function G1 in the case of considering the fast time constant only (equation (14)) and the second transfer function G2 in the case of considering the slow time constant only (equation (18)).

$$\begin{matrix}G s = G1 \cdot G2 = \{ ( 1 - X1 - X2 ) z + ( k1 - 1 ) \} / ( z - 1 ) \cdot \\ ( 1 / X3 ) / ( 1 - {z}^{- 1} {e}^{- T / k3} ) \\ = \{ ( 1 - X1 - X2 ) z / X3 + ( X1 - 1 ) / X3 \} / \\ \{ z - ( 1 + {e}^{- T / X3} ) + {z}^{- 1} {e}^{- T / X3} \}\end{matrix} \qquad ( 19 )$$

Here, if a₁=−(1+e^{-T/X3}), a₂=e^{-T/X3}, b₁=(1−X1−X2)/X3, b₂=(X1−1)/X3, and b₃=0, the transfer function Gs of catalyst 12 becomes as follows.

Gs=(b₁z+b₂)/(z+a₁+a₂z⁻¹)

However, since the RLS method described later is not applied to this format, the transfer function Gs is represented as follows.

Gs=(b₁z+b₂)/(z²+a₁z+a₂)

If the catalyst model is represented using the above, the equation (20) is obtained;

y(t)+a₁y(t−1)+a₂y(t−2)=b₁u(t−k)+b₂u(t−k−1) (20)

wherein y(t); O₂ change discharge amount (O₂ sensor output), u(t); O₂ change input amount, and k; waste time.

Accordingly, if a parameter vector θ(t) and a data vector ψ(t) in regard to y(t) are defined, these vectors can be represented by the equations (21), (22) and (23).

y(t)=θ^{T}ψ(t−k)+e(t) (21)

θ(t)={a₁(t),a₂(t),b₁(t),b₂(t)}^{T} (22)

ψ(t−k)={−y(t−1),−y(t−2),u(t−k),u(t−k−1)}^{T} (23)

Here, in this embodiment, in the same manner as in the first embodiment, there are provided three kinds of catalyst models respectively set with waste times, as the waste time k, namely, a reference waste time k₀ computed based on the intake air amount Qa or based on the intake air amount Q a, an exhaust gas temperature and the like; a waste time k₁′(=k₀−α₁′) which is smaller than the reference waste time k₀; and a waste time k₂′(=k₀+α₂′) which is larger than the reference waste time k₀. (Note, α₁′ and α₂′ are set arbitrarily.)

Then, in the same manner as in the first embodiment, the catalyst models set with each waste time are identified in on-line by utilizing the sequential least square method (RLS method) and each parameter (a₁, a₂, b₁, b₂) is obtained in each model.

A catalyst model selection unit 76 computes an estimation output of the O₂ sensor using each catalyst model identified as above and selects a catalyst model in which a difference between the computed estimation output and an actual O₂ sensor output value becomes minimum.

Here, as in the first embodiment, when the same catalyst model is sequentially selected for predetermined times or more, this catalyst model is selected, and a reference catalyst model may be used until anyone of catalyst models is selected.

Oxygen adsorption amount computation unit 73 computes an oxygen adsorption amount of the catalyst using parameters of the selected catalyst model as follows.

Firstly, since a₁=−(1+e^{-T/X3}), a₂=e^{-T/X3}, b₁=(1−X1−X2)/X3, b₂=(X1−1)/X3 and b₃=0, X1, X2 and X3 are computed by identification parameters a₁, a₂, b₁ and b₂ in accordance with the equations (24), (25) and (26).

X1=k3·b₂+1 (24)

X2=1−X1−X3·b₁=−X3·b₁=−X3·b₂−X3·b₁ (25)

X3=−T/log(−a₁−1)(a₁<1) (26)

X3=−T/log a₂(a₂>0) (27)

By substituting the computed X1(=ap^{1/n}/np) and X2 (=ap^{1/n}(1−n)/np²) for the equation (11), and X3 (=ap^{1/n}/np) for the equation (15), a change amount of O₂ adsorption amount of catalyst 12 is computed and the change amount is integrated to compute an O₂ adsorption amount. The computation of X3 may be performed using either of the equations (26) and (27).

Target air-fuel ratio setting unit 74 computes a deviation between the O₂ adsorption amount of catalyst 12 computed at oxygen adsorption amount computation unit 73 and an optimum oxygen adsorption amount to be set based on engine operating conditions (for example, engine load Tp, rotation speed Ne and the like), and converts the deviation to a target air-fuel ratio, to output the target air-fuel ratio to an air-fuel ratio feedback (F/B) control unit 75.

The optimum oxygen adsorption amount is an oxygen adsorption amount in a range where the purification efficiency of catalyst 12 becomes maximum, and the target air-fuel ratio is a target value of an exhaust gas air-fuel ratio detected by A/F sensor 11 on the upstream side of catalyst 12.

Air-fuel ratio feedback control unit 75 controls fuel injection device (injector 6) to control an air-fuel ratio upstream of catalyst 12 to the target air-fuel ratio.

As described above, the catalyst model most properly representing the waste time of exhaust system including catalyst 12 is selected and the identification parameter of the catalyst model is used for the oxygen adsorption amount computation, so that the oxygen adsorption amount can be accurately computed corresponding to the characteristic fluctuation such as deterioration of catalyst 12 with time lapse. Further, the computed oxygen adsorption amount and the optimum oxygen adsorption amount are compared with each other, and the difference therebetween is converted to be output as the target air-fuel ratio. As a result, the purification efficiency of catalyst 12 is maintained highly.

The entire contents of the basic Japanese Patent Application, No 2001-123248, filed Apr. 20, 2001, a priority of which is claimed, is herein incorporated by reference.

What is claimed is:

1. A control apparatus comprising:
an output detection unit that detects an output of a control object including a waste time;
a storing unit that represents said control object in a transfer function and stores a plurality of control object models set with different waste times, respectively;
a computation unit that sequentially estimates a parameter of each of said plurality of the control object models to identify said plurality of the control object models, and computes a predicted output of said control object using each of identified control object models, and selects a control object model in which a difference between the computed predicted output and an actual output detected at said output detection unit becomes minimum; and
a feedback control unit that feedback controls an input of said control object, while comparing a predicted output computed using the selected control object model with the actual output detected at said output detection unit.

2. A control apparatus according to claim 1,
wherein, when the same control object model in which the difference of the predicted output computed using each of identified control object models and the actual output detected at said output detection unit becomes minimum, is selected for predetermined times or more, selects said control object model.

3. A control apparatus according to claim 1,
wherein said computation unit uses a reference control object model set in advance until any of the control object models is selected.

4. A control apparatus according to claim 1, wherein said control object is a portion from a fuel injection device to an air-fuel ratio detection device in an air-fuel ratio control system for an internal combustion engine, said air-fuel ratio control system performing an air-fuel ratio feedback control by computing a feedback control amount based on a deviation between a target air-fuel ratio and an actual air-fuel ratio.

5. A control apparatus according to claim 4,
wherein said feedback control amount is computed using a sliding mode control.

6. A control apparatus according to claim 1,
wherein said control object is a portion from a first oxygen concentration detection device that detects an oxygen concentration in an exhaust gas on the upstream side of an exhaust gas purification catalyst for an internal combustion engine to a second oxygen concentration detection device that detects an oxygen concentration in the exhaust gas having passed through the exhaust gas purification catalyst on the downstream side of the exhaust gas purification catalyst;
said computation unit executes the identification and selection of each of the control object models set with different waste times, respectively, in which the oxygen concentration detected by said first oxygen concentration detection device is set as an input and the oxygen concentration detected by said second oxygen concentration detection device is set as an output; and
said feedback control unit computes an oxygen adsorption amount of said exhaust gas purification catalyst using the selected control object model and controls an air-fuel ratio on the upstream side of said exhaust gas purification catalyst so that said oxygen adsorption amount becomes equal to an optimum oxygen adsorption amount to be set according to engine operating conditions.

7. A control apparatus comprising:
output detection means for detecting an output of a control object including a waste time;
storing means for representing said control object in a transfer function and storing a plurality of control object models set with different waste times, respectively;
control object model identifying means for sequentially estimating a parameter of each of said plurality of control object models to identify said plurality of control object models;
control object model selection means for computing a predicted output of said control object using each of identified control object models, and selecting a control object model in which a difference between the computed predicted output and an actual output detected by said output detection means becomes minimum; and
feedback control means for feedback controlling an input of said control object, while comparing a predicted output computed using the selected control object model with the actual output detected by said output detection means.

8 A control method,
wherein a control object including a waste time is represented in a transfer function and a plurality of control object models set with different waste times, respectively are stored,
a parameter of each of said plurality of the control object models is sequentially estimated to identify said plurality of the control object models,
a control object model in which a difference between a predicted output computed using each of identified control object models and an actual output detected becomes minimum, is selected, and
an input of said control object is feedback controlled, while comparing a predicted output computed using the selected control object model with the actual output detected.

9. A control method according to claim 8,
wherein, when the same control object model in which the difference of the predicted output computed using each of identified control object models and the actual output detected becomes minimum, is selected for predetermined times or more, said control object model is selected.

10. A control method according to claim 8,
wherein a reference control object model set in advance is used until any of the control object models is selected.

11. A control method according to claim 8, wherein said control object is a portion from a fuel injection device to an air-fuel ratio detection device in an air-fuel ratio control system for an internal combustion engine, said air-fuel ratio control system performing an air-fuel ratio feedback control by computing a feedback control amount based on a deviation between a target air-fuel ratio and an actual air-fuel ratio.

12. A control method according to claim 11,
wherein said feedback control amount is computed using a sliding mode control.

13. A control method according to claim 8,
wherein said control object is a portion from a first oxygen concentration detection device that detects an oxygen concentration in an exhaust gas on the upstream side of an exhaust gas purification catalyst for an internal combustion engine to a second oxygen concentration detection device that detects an oxygen concentration in the exhaust gas having passed through the exhaust gas purification catalyst on the downstream side of the exhaust gas purification catalyst;
each of the control object models set with different waste times, respectively, in which the oxygen concentration detected by said first oxygen concentration detection device is set as an input and the oxygen concentration detected by said second oxygen concentration detection device is set as an output, is identified,
the control object model in which a difference between a predicted oxygen concentration of said control object computed using each of identified control object models and an actual oxygen concentration detected by said second oxygen concentration detection device becomes minimum, is selected, and
an oxygen adsorption amount of said exhaust gas purification catalyst is computed using the selected control object model and an air-fuel ratio on the upstream side of said exhaust gas purification catalyst is feedback controlled so that said oxygen adsorption amount becomes equal to an optimum oxygen adsorption amount to be set according to engine operating conditions.
